(19) United States
(12) Patent Application Publication
(10) Pub. No.: US 2021/0393032 A1
(43) Pub. Date: Dec. 23, 2021

(54) ADJUSTABLE SUPPORT RACK

(71) Applicant: CHEN-SOURCE INC., Taoyuan City (TW)

(72) Inventor: Yuan-Chen CHEN, Taoyuan City (TW)

(21) Appl. No.: 16/903,833

(22) Filed: Jun. 17, 2020

(51) Int. Cl. A47B 96/07; F16M 13/02

(52) U.S. Cl. CPC A47B 96/07; F16M 2200/06; F16M 13/022

(57) ABSTRACT

An adjustable support rack includes a mounting base, a bracket and a support mount that are assembled to form a four-link mechanism, so that once the support mount is rotated, a lower supporting frame of the bracket is displaced, causing a bearing plate of the lower supporting frame to press against a pressure relief valve of a pneumatic cylinder of the bracket for allowing adjustment of the height of the support mount rapidly and smoothly.

### BACKGROUND OF THE INVENTION

### 1. Field of the Invention

The present invention relates to support rack technology and more particularly, to an adjustable support rack, which comprises a mounting base, a bracket and a support mount assembled to form a four-link mechanism, wherein once the support mount is rotated, the support mount drives the lower supporting frame of the bracket to displace, causing the bearing means of the lower supporting frame to press against the pressure relief valve of the pneumatic cylinder of the bracket for allowing adjustment of the height of the support mount rapidly and smoothly.

### 2. Description of the Related Art

In today's home life, monitors such as screens or TVs used in offices, schools or various workstations are very common. From the early picture tube type screens that have been eliminated by the market due to their large size and poor picture quality and due to that they can only receive analog signals, liquid crystal or plasma screens that are light, thin with clear picture quality and can receive analog and digital signals have already taken the place. However, when the thin and light screen is rotated or adjusted on the base, only a small range of angle adjustments can be made, and the position of the center of gravity of the screen must be paid attention to avoid falling. Or, the screen is installed on the wall through a hanger. Although it can ensure the stable positioning of the screen, it is not easy to adjust the position and angle of the screen installation, resulting in many restrictions when the screen is applied.

In order to meet the needs of users to freely adjust the viewing angle of the screen and reduce the space and position on the desktop or workstation occupied by the screen, the screen is generally installed on a support rack that can turn and support the positioning of the screen, and support rack is installed on the desktop or hung on the wall with the clamps or wall mount of the support rack. By means of the multiple swing arms or lifting torque arm of the support rack, the user can conveniently and freely adjust the angle of view and position of the screen. However, the user often needs to operate the keyboard and mouse in actual application, and the screen and keyboard mouse rack can be directly integrated on the swing arm or lifting torque arm of the support rack, allowing the user to watch the screen and perform keyboard and mouse related operations when standing up or sitting down. However, because the height between the screen set on the general support rack and the keyboard mouse rack is mostly a predetermined height that cannot be adjusted, for users who are taller or slightly shorter, there will be somewhat uncomfortable when watching the screen and operating the keyboard and the mouse. Even if there is a lifting column on the support rack that can adjust the lifting height between the screen and the keyboard mouse rack, but the lifting column needs to be assisted by tools or screw locks to adjust the lifting height of the screen, it will cause the user to not easily adjust the stroke of lifting displacement of the screen and is also difficult to apply to users of different heights, causing the user's body or limb to assume an inappropriate posture, which is less ergonomic.

Moreover, when the screen is installed on the lifting column of the support rack, due to the different weight of the support, if the supporting force of the lifting column is not adjusted to be just right or indeed locked, the support rack will be unable to move or sag quickly due to gravity, or even cause damage to the screen structure. In practical application, there are still many deficiencies and inconveniences that must be studied and improved by those engaged in this industry.

Therefore, how to solve the lack and inconvenience of the above-mentioned practices is the direction that the relevant industry urgently wants to study and improve.

### SUMMARY OF THE INVENTION

The present invention has been accomplished under the circumstances in view. It is the main object of the present invention to provide an adjustable support rack, which comprises a mounting base, a bracket, and a support mount. The mounting base comprises first pivot means disposed at a bottom side thereof, and second pivot means spaced from the first pivot means. The bracket comprises an upper supporting frame, a lower supporting frame, and a pneumatic cylinder. The upper supporting frame comprises two first side flanges respectively disposed at two opposite lateral sides, first pivot connection means located at the first side flanges at one end and pivotally connected to the first pivot means, and second pivot connection means located at the first side flanges at an opposite end. The lower supporting frame comprises two second side flanges respectively disposed at two opposite lateral sides, third pivot connection means located at the second side flanges at one end and pivotally connected to the second pivot means, fourth pivot connection means located at the second side flanges at an opposite end, and bearing means located at one end of the lower supporting frame. The upper supporting frame and the lower supporting frame define therebetween an accommodation chamber. The pneumatic cylinder is disposed in the accommodation chamber and supported between the upper supporting frame and the lower supporting frame. The pneumatic cylinder comprises a pressure relief valve located at one end thereof. The support mount comprises two bottom mounting plates perpendicularly located at a bottom side thereof, first mating connection means located at the bottom mounting plates at one end and pivotally connected to the second pivot connection means of the upper supporting frame, and second mating connection means located at the bottom mounting plate at an opposite end and pivotally connected to the fourth pivot connection means of the lower supporting frame. When the support mount is not biased relative to the mounting base and the bracket, the bearing means of the lower supporting frame is released from the pressure relief valve of the pneumatic cylinder, and the pneumatic cylinder is supported between the upper supporting frame and the lower supporting frame. On the contrary, when the support mount is biased relative to the mounting base and the bracket, the support mount drives the lower supporting frame of the bracket to displace, and the bearing means of the lower supporting frame is forced to squeeze the pressure relief valve of the pneumatic cylinder, thereby releasing the pneumatic cylinder between the upper supporting frame and the lower supporting frame. In this way, the height of the support mount can be easily adjusted by turning the support mount to achieve the purpose of improving the operation speed and fluency.

It is another object of the present invention to provide an adjustable support rack, wherein the sliding slots of the second mating connection means of the support mount allow the sliding rod to slide therein, therefore, the sliding rod can be moved in the sliding slots to adjust the angle between the support mount and the bracket. After adjustment of the angle between the support mount and the bracket, the locking lever is operated to lock the sliding rod to the sliding slots. This allows the user to easily adjust the desktop of support mount to the desired angle. Through this design, when the angle of the desktop of the support mount is adjusted, the lower supporting frame of the bracket will not be displaced, and the stability of the pneumatic cylinder of the bracket is maintained.

It is still another object of the present invention to provide an adjustable support rack, wherein the long axis of the third pivot holes of the third pivot connection means forms a contained angle with the length of the second side flanges of the lower supporting frame, so that the angle of pulling the desktop upward is effectively reduced. This in turn reduces the risk of overturning of items placed on the desktop.

It is still another object of the present invention to provide an adjustable support rack, wherein a contained angle is formed between the bearing plate of the bearing means and the second frame plate and this contained angle is less than 90°, thus, when the desktop is pulled up, the stroke in which the bearing plate squeezes the pressure relief valve of the pneumatic cylinder can be increased, so that the pressure relief valve of the pneumatic cylinder is indeed squeezed to perform the pressure relief operation, thereby improving the operation and stability of use.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is an oblique top elevational view of an adjustable support rack in accordance with the present invention.

FIG. 2 corresponds to FIG. 1 when viewed from another angle.

FIG. 3 is an exploded view of the adjustable support rack in accordance with the present invention.

FIG. 4 corresponds to FIG. 3 when viewed from another angle.

FIG. 5 is a side view of the lower supporting frame.

FIG. 6 is a sectional side view of the adjustable support rack before height adjustment.

FIG. 7 is a sectional side view of the adjustable support rack during height adjustment.

FIG. 8 is a sectional side view of the adjustable support rack after height adjustment.

### DETAILED DESCRIPTION OF THE PREFERRED EMBODIMENT

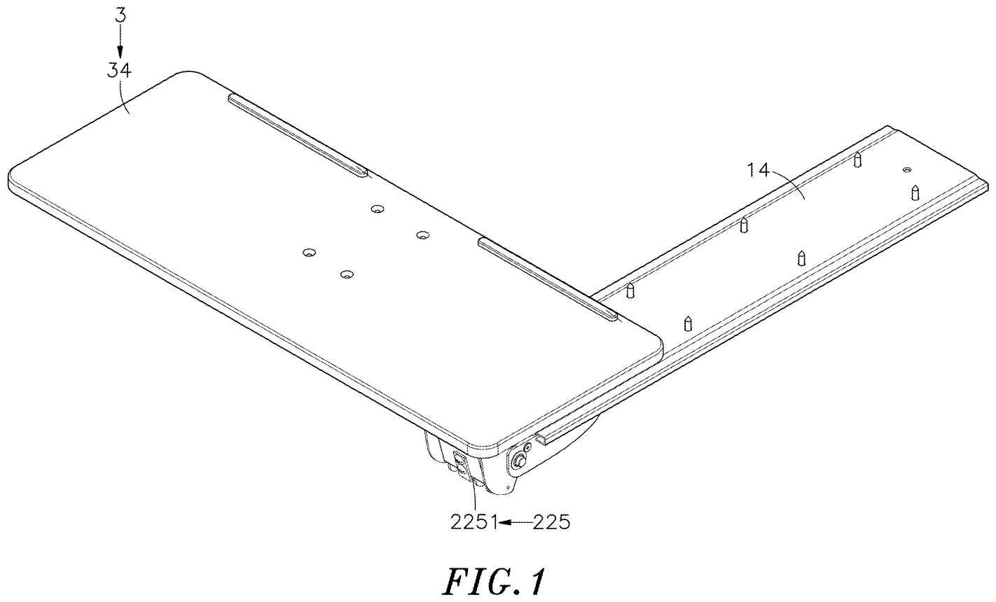

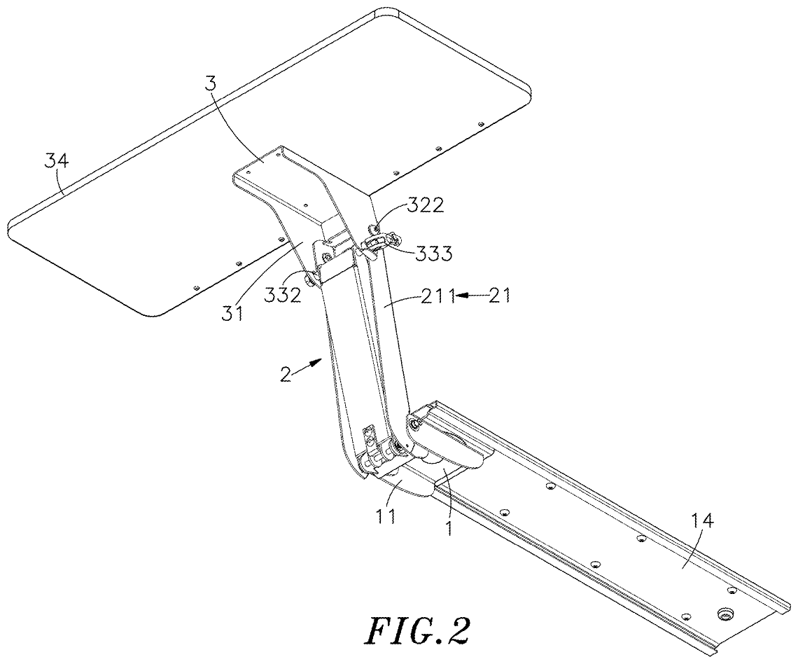

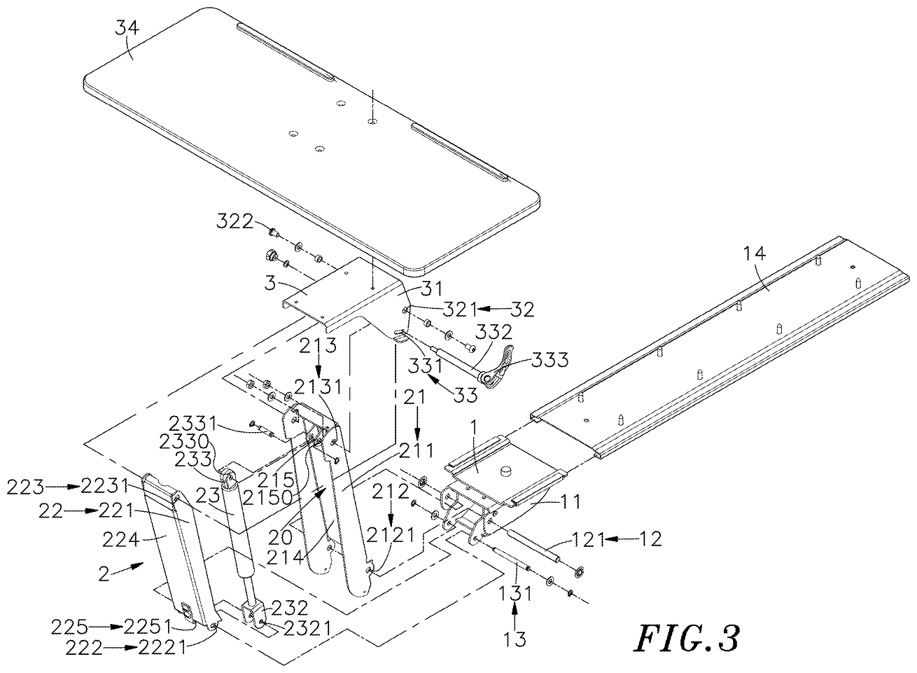

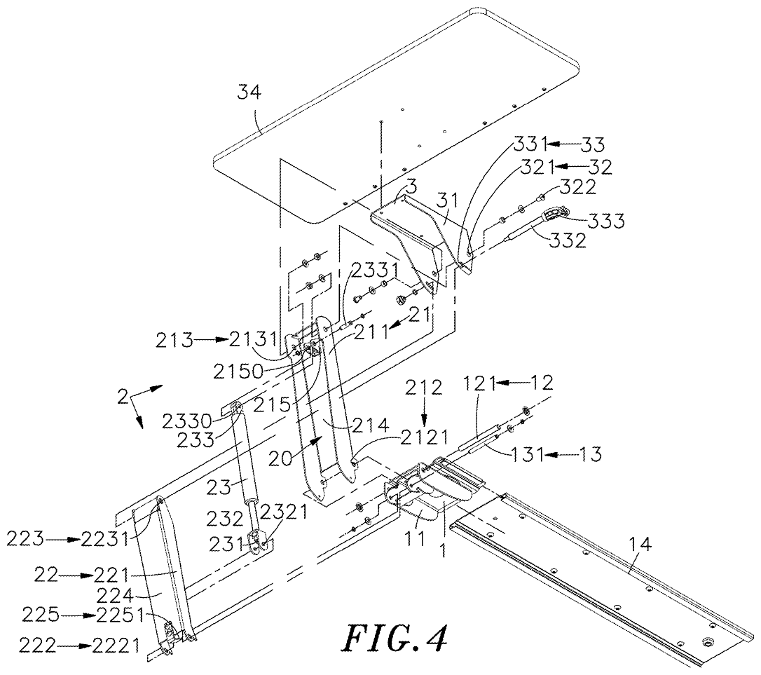

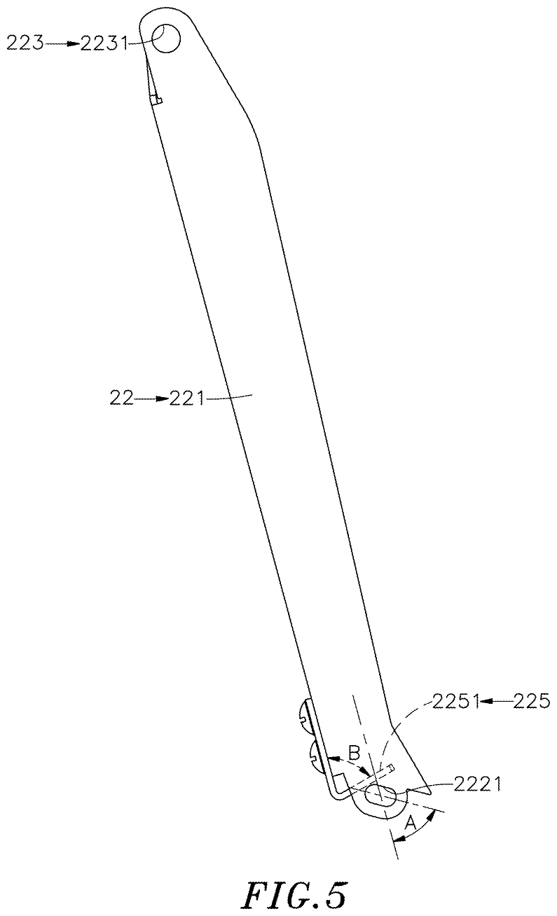

Referring to FIGS. 1-5, an adjustable support rack in accordance with the present invention is shown. The adjustable support rack comprises a mounting base 1, a bracket 2 and a support mount 3.

The mounting base 1 comprises two side panels 11 bilaterally disposed at a bottom side thereof, a first pivot axle 121 of a first pivot mean 12 pivotally connected between the two side panels 11, a second pivot axle 131 of a second pivot mean 13 pivotally connected between the two side panels 11 below the first pivot axle 121, and a mounting plate 14 disposed at an opposing top side thereof.

The bracket 2 comprises an upper supporting frame 21, a lower supporting frame 22 and a pneumatic cylinder 23. The upper supporting frame 21 comprises a first frame plate 214, two first side flanges 211 respectively extended from two opposite lateral sides of the first frame plate 214, a first pivot hole 2121 of first pivot connection means 212 located at one end of each first side flange 211, a second pivot hole 2131 of second pivot connection means 213 located at an opposite end of each first side flange 211, two mounting lugs 215 located at a bottom side of the first frame plate 214, and a through hole 2150 located on each mounting lug 215. The lower supporting frame 22 comprises a second frame plate 224, two second side flanges 221 respectively extended from two opposite lateral sides of the second frame plate 224, an oval-shaped third pivot hole 2221 of third pivot connection means 222 located at one end of each second side flange 221, a fourth pivot hole 2231 of fourth pivot connection means 223 located at an opposite end of each second side flange 221, and a bearing plate 2251 of bearing means 225 located at one end of the second frame plate 224 between the two oval-shaped third pivot holes 2221.

An accommodation chamber 20 is defined between the upper supporting frame 21 and the lower supporting frame 22 of the bracket 2 and used to accommodate the pneumatic cylinder 23. The pneumatic cylinder 23 comprises a pressure relief valve 231 located at one end thereof, a U-shaped locating plate 232 fixedly disposed around the pressure relief valve 231, two holes 2321 respectively located on two opposite ends of the U-shaped locating plate 232 corresponding to the two third pivot holes 2221, a mating connection member 233 located at an opposite end thereof remote from the pressure relief valve 231, two mating connection holes 2330 respectively located on two opposite ends of the mating connection member 233 corresponding to the through holes 2150 of the two mounting lugs 215, and a connection rod 2331 mounted in the mating connection holes 2330 and the through holes 2150.

Furthermore, the long axis of the third pivot holes 2221 of the third pivot connection means 222 forms a contained angle A with the length of the second side flanges 221 of the lower supporting frame 22, and the contained angle A is less than 90°, preferably 60°. A contained angle B is formed between the bearing plate 2251 of the bearing means 225 and the second frame plate 224, and this contained angle B is less than 90°.

The support mount 3 comprises a desktop 34 located at a top side thereof, two bottom mounting plates 31 perpendicularly located at a bottom side of the desktop 34, a mating connection hole 321 of first mating connection means 32 located on each bottom mounting plate 31, a pivot axle 322 mounted in the two mating connection holes 321, a arc-shaped sliding slot 331 of second mating connection means 33 located on each bottom mounting plate 31 below the respective mating connection hole 321, a sliding rod 332 slidably mounted in the sliding slots 331, and a locking lever 333 mounted at one end and operable to lock the sliding rod 332 to the sliding slots 331.

When the adjustable support rack is actually assembled, you can first pivot one end of the bracket 2 to the mounting base 1. At this time, insert the first side flanges 211 of the upper supporting frame 21 of the bracket 2, the second side flanges 221 of the lower supporting frame 22 and the locating plate 232 of the pneumatic cylinder 23 in between the side panels 11 of the mounting base 1, and then respectively pivotally connect the first pivot holes 2121 of the first pivot connection means 212, the third pivot holes 2221 of the third pivot connection means 222 and the holes 2321 of the locating plate 232 to the first pivot axle 121 of the first pivot means 12 and the second pivot axle 131 of the second pivot means 13. Thus, one end of the bracket 2 is pivotally connected to the mounting base 1. Then, pivotally connect the support mount 3 to the other end of the bracket 2. At this time, insert the other ends of the first side flanges 211 and the second side flanges 221 in between the bottom mounting plates 31 of the support mount 3, and then respectively pivotally connect the second pivot holes 2131 of the second pivot connection means 213 and the fourth pivot holes 2231 of the fourth pivot connection means 223 to the pivot axles 322 of the first mating connection means 32 and the sliding rod 332 of the second mating connection means 33. Thus, the other end of the bracket 2 is pivotally connected to the support mount 3. In this way, the mounting base 1, the bracket 2 and the support mount 3 are assembled.

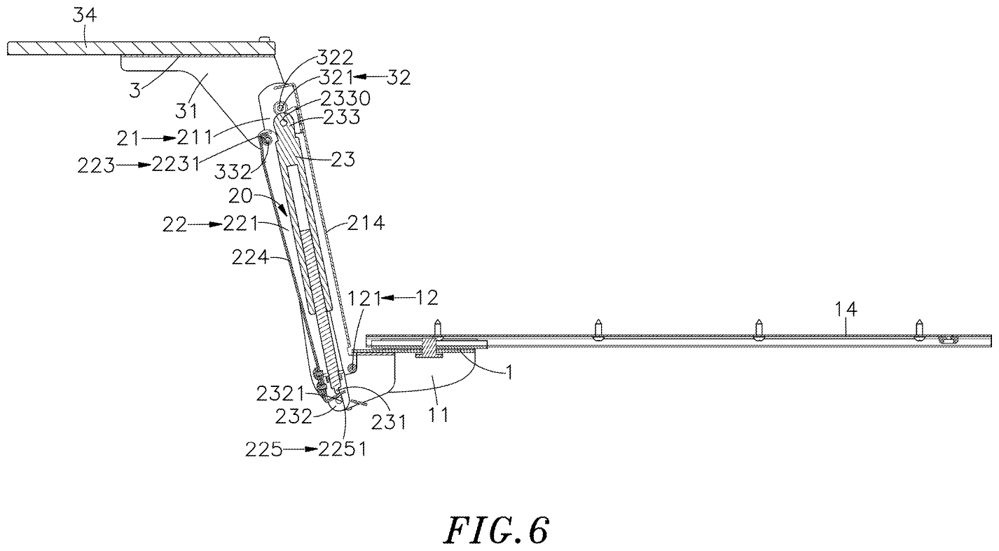

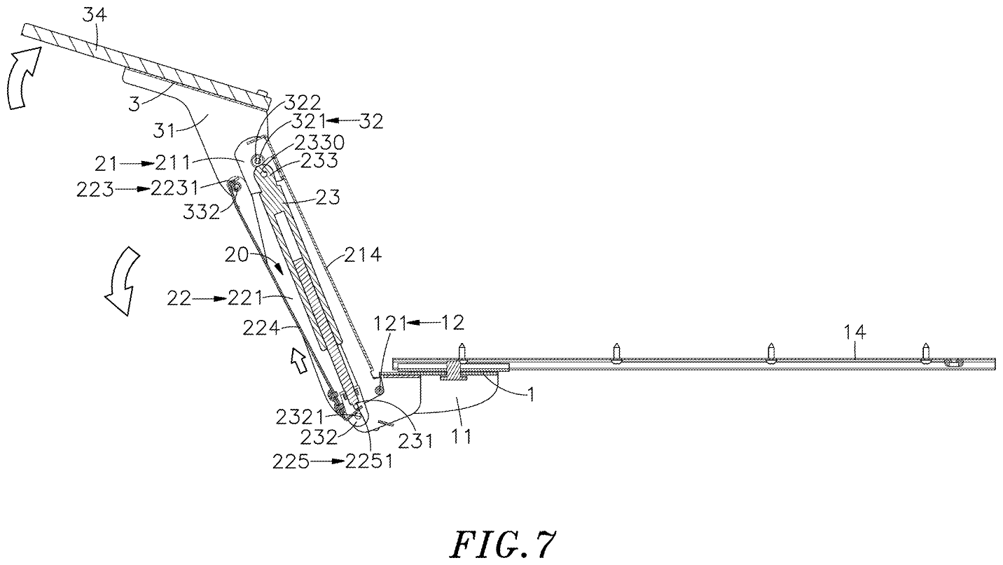

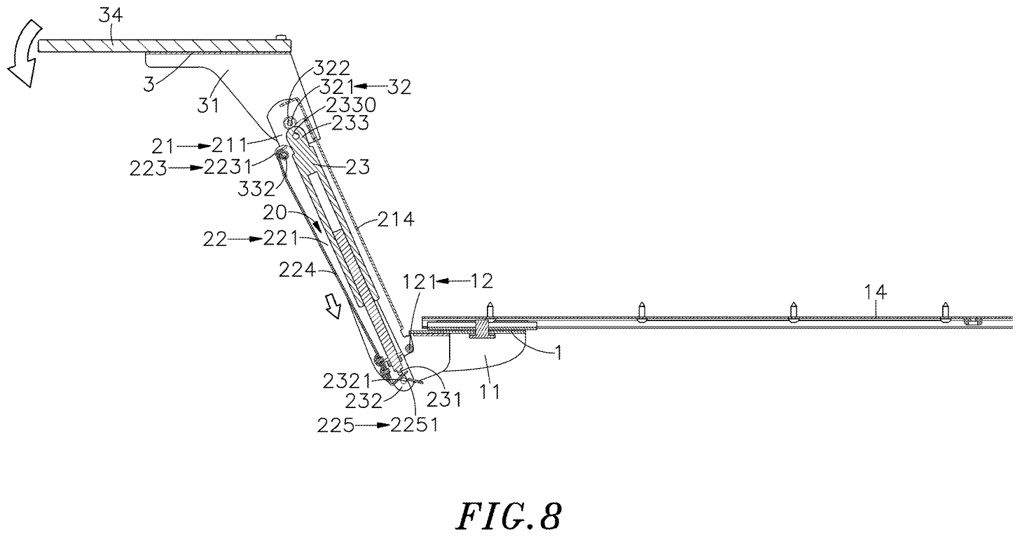

Referring to FIGS. 6-8, which are sectional side views of the adjustable support rack before height adjustment, during height adjustment an after height adjustment. It can be clearly seen from the drawings that when it is desired to adjust the height of the desktop 34 of the support mount 3, you can first pull the desktop 34 up to rotate the support mount 3 clockwise. Because the fourth pivot holes 2231 of the fourth pivot connection means 223 of the lower supporting frame 22 of the bracket 2 are pivotally connected to the sliding rod 332 of the second mating connection means 33 of the support mount 3, the lower supporting frame 22 of the bracket 2 is moved forward with the rotation of the support mount 3, causing the bearing plate 2251 of the bearing means 225 at the lower supporting frame 22 to be displaced forward to the pressure relief valve 231 of the pneumatic cylinder 23. At this time, the pneumatic cylinder 23 will perform the pressure relief operation, and the user can rotate the bracket 2 up or down to turn the first pivot holes 2121 of the first pivot connection means 212 of the bracket 2, the third pivot holes 2221 of the third pivot connection means 222 and the holes 2321 of the locating plate 232 on the first pivot axle 121 of the first pivot means 12 and the second pivot axle 131 of the second pivot means 13 respectively, allowing the bracket 2 to be adjusted to the desired angle, and thus, the desktop 34 of the support mount 3 can be adjusted to the desired height.

Since the third pivot holes 2221 of the third pivot connection means 222 of the lower supporting frame 22 are oval-shaped, when the desktop 34 of the support mount 3 is pulled up, the second pivot axle 131 of the second pivot means 13 of the mounting base 1 can slide in the third pivot holes 2221 of the third pivot connection means 222, so that the lower supporting frame 22 can be moved relative to the second pivot axle 131, thereby improving the operational margin to facilitate the upward movement of the desktop 34 of the support mount 3. Since the long axis of the third pivot holes 2221 of the third pivot connection means 222 forms a contained angle A with the length of the second side flanges 221 of the lower supporting frame 22, the angle of pulling the desktop 34 upward is effectively reduced. Furthermore, since a contained angle B is formed between the bearing plate 2251 of the bearing means 225 and the second frame plate 224 and this contained angle B is less than 90°, when the desktop 34 is pulled up, the stroke in which the bearing plate 2251 squeeze the pressure relief valve 231 of the pneumatic cylinder 23 can be increased, so that the pressure relief valve 231 of the pneumatic cylinder 23 is indeed squeezed to perform the pressure relief operation. After the desktop 34 of the support mount 3 is adjusted to the desired height, the user can release the desktop 34, allowing the support mount 3 to be rotated counterclockwise to the original position, so that the lower supporting frame 22 of the bracket 2 can move back as the support mount 3 rotates back. By this, the bearing plate 2251 of the bearing means 225 at one end of the lower supporting frame 22 is displaced backward without being squeezed to the pressure relief valve 231 of the pneumatic cylinder 23. At this time, the pneumatic cylinder 23 will be charged, to support the upper supporting frame 21 of the bracket 2, so that the support mount 3 is stably positioned without displacement or shaking. This allows the user to place a laptop, a tablet or any other items on the desktop 34.

Furthermore, since the sliding slots 331 of the second mating connection means 33 of the support mount 3 are arched for sliding displacement of the sliding rod 332, and the sliding rod 332 is pivotally connected to the fourth pivot holes 2231 of the fourth pivot connection means 223, you can slide the sliding rod 332 to different positions in the sliding slots 331 to adjust the angle between the support mount 3 and the bracket 2, and then operate the locking lever 333 to lock the sliding rod 332 to the sliding slots 331. In this way, the user can easily adjust the desktop 34 of the support mount 3 to the desired angle.

The present invention has the following advantages:

1. After the mounting base 1, the bracket 2 and the support mount 3 are assembled, a four-link mechanism is formed. When the support mount 3 is not rotated, the bearing means 225 of the lower supporting frame 22 of the bracket 2 is not pressed against the pressure relief valve 231 of the pneumatic cylinder 23, and the pneumatic cylinder 23 inside the bracket 2 is supported between the upper supporting frame 21 and the lower supporting frame 22. When the support mount 3 is rotated, the support mount 3 carries the lower supporting frame 22 of the bracket 2 to move, causing the bearing means 225 of the lower supporting frame 22 to press against the pressure relief valve 231 of the pneumatic cylinder 23. At this time, the pneumatic cylinder 23 is not supported between the upper supporting frame 21 and the lower supporting frame 22, allowing the user to adjust the angle of the bracket 2 to further adjust the height of the support mount 3. The user can easily adjust the height of the support mount 3 by turning the support mount 3 with one hand, thereby improving the operation speed and fluency, and becoming more intuitive, so as to achieve the effect of improving the convenience of use.

2. The sliding slots 331 of the second mating connection means 33 of the support mount 3 allow the sliding rod 332 to slide therein and the sliding rod 332 is pivotally connected to the fourth pivot holes 2231 of the fourth pivot connection means 223, therefore, the sliding rod 332 can be moved in the sliding slots 331 to adjust the angle between the support mount 3 and the bracket 2. After adjustment of the angle between the support mount 3 and the bracket 2, the locking lever 333 is operated to lock the sliding rod 332 to the sliding slots 331. This allows the user to easily adjust the desktop 34 of the support mount 3 to the desired angle. Through this design, when the angle of the desktop 34 of the support mount 3 is adjusted, the lower supporting frame 22 of the bracket 2 will not be displaced, and the stability of the pneumatic cylinder 23 of the bracket 2 is maintained.

3. Since the long axis of the third pivot holes 2221 of the third pivot connection means 222 forms a contained angle A with the length of the second side flanges 221 of the lower supporting frame 22, the angle of pulling the desktop 34 upward is effectively reduced. This in turn reduces the risk of overturning of items placed on the desktop 34.

4. Since a contained angle B is formed between the bearing plate 2251 of the bearing means 225 and the second frame plate 224 and this contained angle B is less than 90°, when the desktop 34 is pulled up, the stroke in which the bearing plate 2251 squeezes the pressure relief valve 231 of the pneumatic cylinder 23 can be increased, so that the pressure relief valve 231 of the pneumatic cylinder 23 is indeed squeezed to perform the pressure relief operation, thereby improving the operation and stability of use.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. An adjustable support rack, comprising:
a mounting base comprising first pivot means disposed at a bottom side thereof and second pivot means spaced from said first pivot means;
a bracket comprising an upper supporting frame, a lower supporting frame and a pneumatic cylinder, said upper supporting frame comprising two first side flanges respectively disposed at two opposite lateral sides, first pivot connection means located at said first side flanges at one end and pivotally connected to said first pivot means and second pivot connection means located at said first side flanges at an opposite end, said lower supporting frame comprising two second side flanges respectively disposed at two opposite lateral sides, third pivot connection means located at said second side flanges at one end and pivotally connected to said second pivot means, fourth pivot connection means located at said second side flanges at an opposite end and bearing means located at said lower supporting frame at one end, said upper supporting frame and said lower supporting frame defining therebetween an accommodation chamber, said pneumatic cylinder being disposed in said accommodation chamber and supported between said upper supporting frame and said lower supporting frame, said pneumatic cylinder comprising a pressure relief valve located at one end thereof; and
a support mount comprising two bottom mounting plates perpendicularly located at a bottom side thereof, first mating connection means located at said bottom mounting plates at one end and pivotally connected to said second pivot connection means of said upper supporting frame, and second mating connection means located at said bottom mounting plate at an opposite end and pivotally connected to said fourth pivot connection means of said lower supporting frame;
when said support mount is not biased relative to said mounting base and said bracket, said bearing means of said lower supporting frame is released from said pressure relief valve of said pneumatic cylinder, and said pneumatic cylinder is supported between said upper supporting frame and said lower supporting frame; when said support mount is biased relative to said mounting base and said bracket, said support mount drives said lower supporting frame of said bracket to displace and said bearing means of said lower supporting frame is forced to squeeze said pressure relief valve of said pneumatic cylinder, thereby releasing said pneumatic cylinder between said upper supporting frame and said lower supporting frame.

2. The adjustable support rack as claimed in claim 1, wherein said mounting base comprises two side panels located at the bottom side thereof; said first pivot means comprises a first pivot axle connected between said two side panels; said second pivot means comprises a second pivot axle connected between said two side panels and spaced from said first pivot axle; said first pivot connection means of said upper supporting frame comprises two first pivot holes pivotally coupled to said first pivot axle; said third pivot connection means of said lower supporting frame comprises two third pivot holes slidably and pivotally coupled to said second pivot axle.

3. The adjustable support rack as claimed in claim 2, wherein a pneumatic cylinder further comprises a locating plate disposed around a pressure relief valve and pivotally connected to said second pivot axle, and two holes respectively located on two opposite ends of said locating plate corresponding to said third pivot holes for the mounting of said second pivot axle.

4. The adjustable support rack as claimed in claim 2, wherein said third pivot holes of said third pivot connection means are oval-shaped, and the long axis of said third pivot holes forms a contained angle with the length of a second side flanges of said lower supporting frame.

5. The adjustable support rack as claimed in claim 1, wherein said mounting base further comprises a mounting plate located at a top side thereof.

6. The adjustable support rack as claimed in claim 1, wherein said second pivot connection means of said upper supporting frame comprises two second pivot holes; said fourth pivot connection means of said lower supporting frame comprises two fourth pivot holes; said first mating connection means comprises said two second pivot holes respectively located on said two bottom mounting plates of said support mount corresponding to mating connection holes, and a pivot axle pivotally connected to said mating connection holes and said second pivot holes; said second mating connection means comprises two sliding slots respectively located on said two bottom mounting plates corresponding to said fourth pivot holes, a sliding rod slidably mounted in said sliding slots, and a locking lever mounted at one end of said sliding rod and operable to lock said sliding rod to said sliding slots.

7. The adjustable support rack as claimed in claim 1, wherein said upper supporting frame further comprises a first frame plate, said first frame plate connected between said two first side flanges, two mounting lugs located at a bottom side of said first frame plate, and a through hole located on each said mounting lug; said pneumatic cylinder further comprises a mating connection member located at an opposite end thereof remote from said pressure relief valve, two mating connection holes respectively located on two opposite ends of said mating connection member corresponding to said through holes, and a connection rod mounted in said mating connection holes and said through holes.

8. The adjustable support rack as claimed in claim 1, wherein said lower supporting frame further comprises a second frame plate, said second frame plate connected between said two second side flanges; said bearing means comprises a bearing plate located at one end of said second frame plate for pressing on said pressure relief valve of said pneumatic cylinder.

9. The adjustable support rack as claimed in claim 8, wherein said bearing plate of said bearing means forms a contained angle with said second frame plate, and said contained angle is less than 90°.

10. The adjustable support rack as claimed in claim 1, wherein said support mount further comprises a desktop located at a top side thereof.
